(19) United States
(12) Patent Application Publication
(10) Pub. No.: US 2022/0134138 A1
(43) Pub. Date: May 5, 2022

(54) MULTIFUNCTIONAL PROTECTIVE MASK WITH SUCKING AND WHISTLING

(71) Applicant: MOTEX HEALTHCARE CORP., TAIPEI (TW)

(72) Inventors: Yung-Chu CHENG, TAIPEI (TW); Chien-Feng CHENG, TAIPEI (TW); Yu-Liang CHENG, TAIPEI (TW)

(73) Assignee: MOTEX HEALTHCARE CORP., TAIPEI (TW)

(21) Appl. No.: 17/431,578

(22) PCT Filed: Feb. 12, 2020
(86) PCT No.: PCT/CN2020/074788

§ 371 Date: Aug. 17, 2021

(30) Foreign Application Priority Data
Feb. 21, 2019 (CN) 201910128522.2

(51) Int. Cl. A62B 9/06; A41D 13/11; A62B 18/02

(52) U.S. Cl. CPC A62B 9/06; A62B 18/025; A41D 13/1115

(57) ABSTRACT

A multifunctional protective mask with sucking and whistling includes a mask body, a slit and a fixing section. The mask body includes folded first wrinkle and second wrinkle, and a splicing section formed at the junction of the first wrinkle and the second wrinkle. The slit is located between the second wrinkle and the splicing section. The fixing section fixes the first wrinkle, the splicing section and the second wrinkle. Therefore, the present invention can provide the user with many functions such as the convenience of inhaling tea, coffee, beverages, nasogastric tube feeding or whistling while wearing. At the same time, the mask has good bacterial and virus filtration efficiency (PFE/BFE) and closeness. The invention can be automatically produced, has a short process time, has many advantages such as low cost, easy commercialization and mass production, and benefits the society.

### BACKGROUND OF THE INVENTION

### 1. Field of the Invention

The present invention relates to protective masks, in particular to a multifunctional protective mask with sucking and whistling.

### 2. Description of the Related Art

In recent years, the rapid development of industry and cities, various factories, coal-fired power plants, and large amounts of car and motorcycle exhaust emissions have caused serious air pollution. Dust (fine suspended particles PM2.5) and pollen in the environment enter the human body through the respiratory tract, can cause various diseases such as allergies, asthma or colds, sneezing, runny nose, etc., causing the body's immunity to decline, causing various diseases that seriously affect human health.

In order to block and isolate air pollution and prevent germs and disease transmission, wearing a mask is the most convenient, cost-effective and effective method. But there are still many inconveniences when wearing a mask. For example, drinking water is a basic human physiological need (at least 2,000 cc or eight to ten glasses of water per day) or people often use straws to drink drinks. For people who need to wear masks for a long time or people in hospitals or public places, many precautions and steps are required for the process of inhaling tea, coffee, and beverages, such as removing the mask and putting it on again or replacing it directly. If you are not careful, you may be exposed to infection or inhale dirty air. Wearing and taking off masks frequently can also increase the chance of infection. In addition, there are 200,000 patients who use nasogastric tube feeding in Taiwan every year. Most of them walk around in medical institutions without wearing a mask or without a suitable mask, but they usually have low immunity and require such innovative masks. In addition, when traffic police wear masks on duty, it is inconvenient to whistle, shout or communicate with others. Therefore, in order to solve the above-mentioned problem that the traffic police cannot blow the whistle when on duty, a mask that can be used by the traffic police to whistle is proposed.

As shown in FIG. 19, it is a traffic police mask disclosed in Chinese Patent Application Publication No. CN103110215A. The cover is composed of an upper cover 3A and a lower cover 4A. The lower part of the upper cover 3A and the upper part of the lower cover 4A overlap each other. There are suture threads 5A on the left and right of the joint between the lower part of the upper cover 3A and the lower cover 4A. There is a whistle gap 7A in the middle of the left and right two sutures 5A. The left and right sides of the upper cover 3A and the lower cover 4A are respectively provided with a fixing belt 2A, and the fixing belts 2A fix the upper cover 3A and the lower cover 4A together. In this way, it can effectively block the dust in the environment from entering the human body; ensure that the traffic police blows the whistle and perform duties normally under the conditions of cold and large air pollution.

In the above-mentioned published patent, the manufacturing process of the mask requires the lower part of the upper cover 3A and the upper part of the lower cover 4A to overlap each other, and then fix the two sides with the fixing belts 2A, and stitch the left and right two sutures 5A on the left and right sides of the whistle gap 7A by stitching. Therefore, the production process is complicated, time-consuming and labor-intensive, high cost, difficult to commercialize, and not economical.

Therefore, how to design a protective mask that can improve the above deficiencies is a major issue that needs to be solved urgently.

### SUMMARY OF THE INVENTION

The present invention has been accomplished under the circumstances in view. It is the main object of the present invention to provide a multifunctional protective mask with sucking and whistling, which has the advantages of automatic production, short process time, low cost, easy commercialization and mass production, and benefits the society.

The second object of the present invention is to provide a multifunctional protective mask with sucking and whistling, which can prevent the mask from leaking and maintain a good tightness.

The third object of the present invention is to provide a multifunctional protective mask with sucking and whistling, which can still eat and drink while wearing the multifunctional protective mask with sucking and whistling.

The fourth purpose of the present invention is to provide a multifunctional protective mask with sucking and whistling, which is convenient for traffic policemen to wear masks on duty, and they can still blow the whistle for traffic control or perform other duties.

To achieve these and other objects of the present invention, a multifunctional protective mask with sucking and whistling of the present invention comprises a mask body, a slit and a fixing section. The mask body comprises folded first wrinkle and second wrinkle, and a splicing section formed at the junction of the first wrinkle and the second wrinkle. The slit is located between the second wrinkle and the splicing section. The fixing section fixes the first wrinkle, the splicing section and the second wrinkle.

Preferably, the fixing section is located on left and right sides under the slit.

Preferably, the fixing section is parallel to the slit, and the length of the slit is in the range of 5 mm-60 mm.

Preferably, the multifunctional protective mask with sucking and whistling further comprises a binding strap set. The binding strap set comprises a plurality of binding straps respectively fixed along two opposite sides of the mask body.

Preferably, the multifunctional protective mask with sucking and whistling further comprises a pair of reflexed sheets. The reflexed sheets extend from two opposite sides of the mask body and are fixed to the mask body with the ends thereof after being folded back.

Preferably, the multifunctional protective mask with sucking and whistling further comprises a pair of airtight sheets. The airtight sheets are respectively wrapped on two opposite sides of the mask body with the ends thereof fixed to the mask body.

Preferably, the airtight sheets are selectively a single-layer structure or a multi-layer structure.

Preferably, the mask body is formed with two longitudinal wrinkles. The longitudinal wrinkles pass through the first wrinkle and the second wrinkle respectively.

Preferably, the mask body has a zigzag cross section.

Preferably, the multifunctional protective mask with sucking and whistling further comprises an implantable nose pad arranged in the upper part of the mask body.

The present invention has the following advantages due to the adoption of the above technical scheme:

1. The multifunctional protective mask with sucking and whistling of the present invention can be automatically produced, has the advantages of short process time, low cost, easy commercialization and mass production, and benefits the society.

2. The multifunctional protective mask with sucking and whistling of the present invention is provided with a slit between the second wrinkle and the splicing section, and the slit is still closed after the mask is worn, which can prevent the mask from leaking and maintain a good tightness.

3. The user of the multifunctional protective mask with sucking and whistling of the present invention can insert the straw into the mask body slit and put it in the mouth while wearing the mask, so as to facilitate the inhalation of tea, coffee, beverages or nasogastric tube feeding through the straw. Therefore, you can still eat and drink when wearing the multifunctional protective mask with sucking and whistling.

4. A user (such as traffic police) using the multifunctional protective mask with sucking and whistling of the present invention can put the whistle into the mask body slit and put it in the mouth, so that when the traffic police wear the mask on duty, the traffic police can still blow the whistle for traffic control or perform other tasks.

### BRIEF DESCRIPTION OF THE DRAWINGS

FIG. 1 is a front view of a multifunctional protective mask with sucking and whistling in accordance with a first preferred embodiment of the present invention.

FIG. 2 is a rear side view of the multifunctional protective mask with sucking and whistling in accordance with the first preferred embodiment of the present invention.

FIG. 3 is a sectional view taken along line A-A of FIG. 1.

FIG. 4 is a sectional view taken along line B-B of FIG. 1.

FIG. 5 is a perspective view of the multifunctional protective mask with sucking and whistling in accordance with the first preferred embodiment of the present invention.

FIG. 6 is a use state diagram of the multifunctional protective mask with sucking and whistling in accordance with the first preferred embodiment of the present invention.

FIG. 7 is a front view of a multifunctional protective mask with sucking and whistling in accordance with a second preferred embodiment of the present invention.

FIG. 8 is a sectional view taken along line C-C of FIG. 7.

FIG. 9 is a front view of a multifunctional protective mask with sucking and whistling in accordance with a third preferred embodiment of the present invention.

FIG. 10 is a sectional view taken along line D-D of FIG. 9.

FIG. 11 is a front view of a multifunctional protective mask with sucking and whistling in accordance with a fourth preferred embodiment of the present invention.

FIG. 12 is a sectional view taken along line E-E of FIG. 11.

FIG. 13 is a front view of a multifunctional protective mask with sucking and whistling in accordance with a fifth preferred embodiment of the present invention.

FIG. 14 is a front view of a multifunctional protective mask with sucking and whistling in accordance with a sixth preferred embodiment of the present invention.

FIG. 15 is a sectional view taken along line F-F of FIG. 14.

FIG. 16 is a front view of a multifunctional protective mask with sucking and whistling in accordance with a seventh preferred embodiment of the present invention.

FIG. 17 is a front view of a multifunctional protective mask with sucking and whistling in accordance with an eighth preferred embodiment of the present invention.

FIG. 18 is a front view of a multifunctional protective mask with sucking and whistling in accordance with a ninth preferred embodiment of the present invention.

FIG. 19 is a front view of a traffic police mask in the prior art.

### DETAILED DESCRIPTION OF THE INVENTION

Below in conjunction with specific preferred embodiments, the present invention is further described. It should be understood that these preferred embodiments are only used to illustrate the present invention and not to limit the scope of the present invention. In addition, it should be understood that after reading the content set forth in the present invention, those skilled in the art can make various changes or modifications to the present invention, and these equivalent forms also fall within the scope of the claims of the present invention.

As shown in FIGS. 1 to 5, embodiment 1, a multifunctional protective mask with sucking and whistling provided by the present invention, comprises a mask body 10, a slit 20, a fixing section 30, and an ear strap set 40, which are respectively discussed as follows:

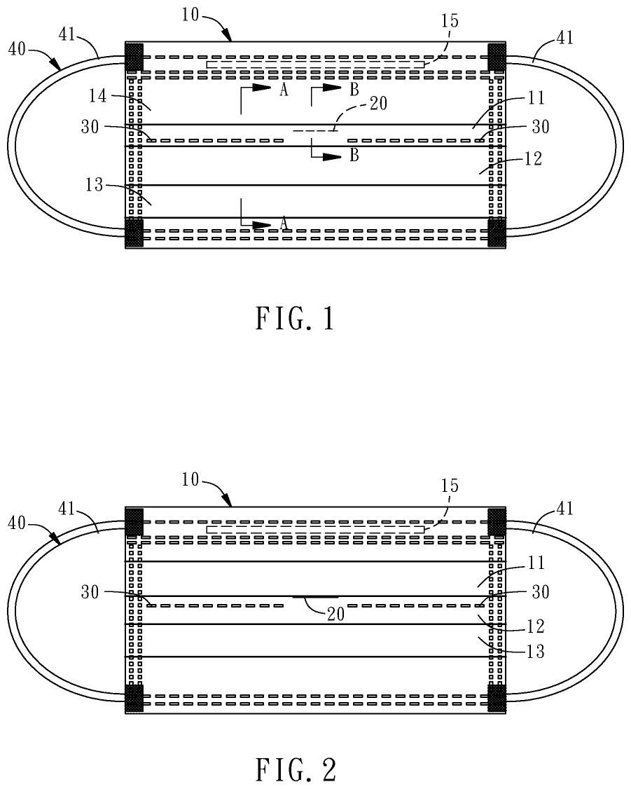

As shown in FIG. 1, the mask body 10 comprises a nose bridge piece 15, and folded first wrinkle 11, second wrinkle 12, third wrinkle 13 and fourth wrinkle 14, wherein the cross-section along A-A is zigzag. As shown in FIG. 2, a splicing section 16 is formed at the junction of the first wrinkle 11 and the second wrinkle 12, and the splicing section 16 is spliced between the first wrinkle 11 and the second wrinkle 12. The mask body 10 is provided with an outer layer 17, at least one middle layer 18 and an inner layer 19 in sequence. As shown in FIG. 8, the outer layer 17 is a water-repellent layer that can be, for example, a non-woven fabric with a water-repellent function to prevent the penetration of water and liquid. The middle layer 18 is a filter layer, which can be, for example, an electrostatic high-density filter non-woven fabric (or an electrostatic high-density melt-blown non-woven fabric) to filter dust, viruses, and bacteria. The inner layer 19 is a hydrophilic layer, which can be, for example, a hydrophilic superfine composite fiber nonwoven fabric, which is soft and comfortable, and effectively absorbs moisture. The mask body 10 can include three or four layers, such as activated carbon masks, with five or six layers or more, such as dust masks in the U.S. standard N series or the European standard FFP series, but it is not limited.

The slit 20 may be, for example, a horizontal straight line and may have a length ranging from 5 mm to 60 mm (millimeters), which is opened at about the center of the mask body 10 and located between the splicing section 16 and the second wrinkle 12. Due to wrinkles or folding, viewed from the front of the mask body 10 (as shown in FIG. 1), the slit 20 is located behind the first wrinkle 11, that is, the slit 20 is covered by the first wrinkle 11, and the slit 20 cannot be seen, so the slit 20 is represented by a dotted line. In addition, when viewed from the back of the mask body 10 (as shown in FIG. 2), the slit 20 can be seen.

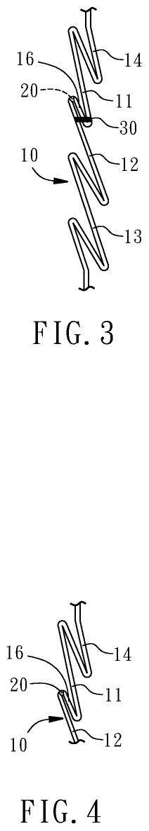

The fixing section 30, as shown in FIG. 3, fixes the first wrinkle 11, the splicing section 16 and the second wrinkle 12, and is located on the left and right sides below the slit 20 and can be parallel to the slit 20. And there is no fixing section 30 directly below the slit 20 (as shown in FIG. 3). This can provide other objects to extend into the slit 20 through the part without the fixing section 30. The other objects can be straws, nasogastric tubes, whistles or other objects.

The ear strap set 40 comprises two ear straps 41, which can be fixed on the left and right sides of the mask body 10 for ear-hooks. The ear strap 41 is fixed to the upper end of the mask body 10 at one end, and the other end is fixed to the lower end of the mask body 10. The ear strap 41 is an ear hook or a headband, or a strap, but it is not limited to this.

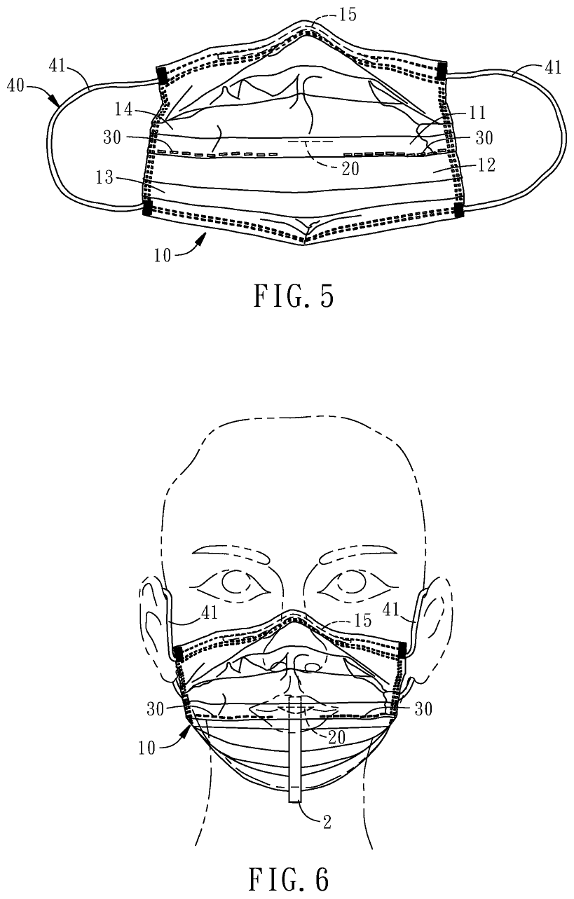

It should be noted that, as shown in FIG. 5, after the multifunctional protective mask with sucking and whistling in this first preferred embodiment is expanded, the second wrinkle 12, the third wrinkle 13 and the fourth wrinkle 14 can also be expanded, and only the part of the first wrinkle 11 fixed by the fixing section 30 cannot be fully opened. This is caused by the fixing section 30 fixed to the first wrinkle 11, the splicing section 16 and the second wrinkle 12. At this time, the slit 20 remains, for example, a horizontal straight line, and is hidden in the mask body 10. After the user wears the multifunctional protective mask with sucking and whistling in this first preferred embodiment or unfolds the multifunctional protective mask with sucking and whistling in this first preferred embodiment, the slit 20 is still closed, so it can prevent the mask from leaking and maintain good bacterial and virus filtration efficiency PFE/BFE and closeness.

For example, after the user wears the multifunctional protective mask with sucking and whistling in this first preferred embodiment, when they need to suck, as shown in FIG. 5, the user can insert the straw 2 into the part of the mask body 10 that does not have the fixing section 30 (that is, the part below the slit 20), and then penetrate into the slit 20 and extend it into the mouth, and you can easily suck tea, coffee, drinks or nasogastric tube feeding through the straw. Therefore, users can still easily perform tasks such as eating and drinking when wearing a multifunctional protective mask with sucking and whistling in this first preferred embodiment.

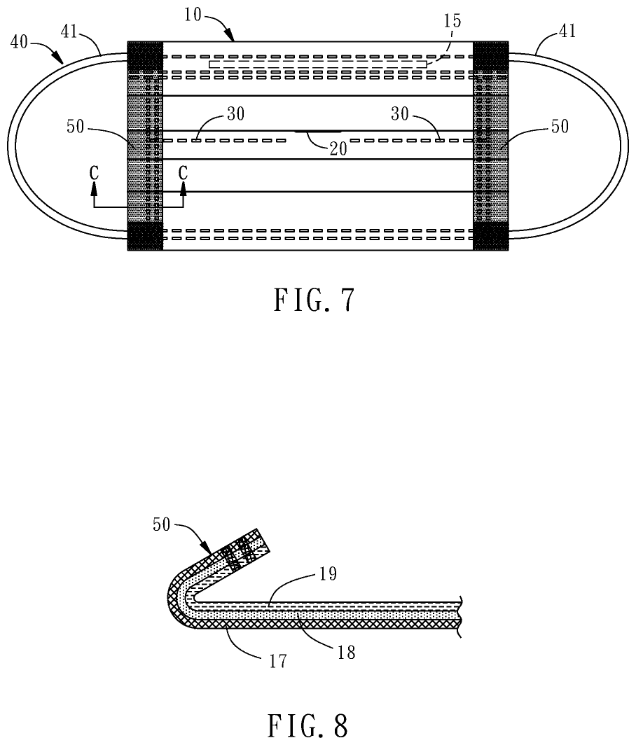

As shown in FIG. 7, FIG. 8, a second preferred embodiment of multifunctional protective mask with sucking and whistling provided by the present invention is substantially similar to the aforesaid first preferred embodiment. The difference between this second preferred embodiment and the previous first preferred embodiment is that it also includes a pair of reflexed sheets 50, which respectively extend from both sides of the mask body 10, and the reflexed sheets 50 are fixed to the mask body 10 at both ends. The reflexed sheets 50 can fill the gaps between the sides of the face and the mask, preventing the mask from leaking, and greatly improving the tightness and safety of the mask.

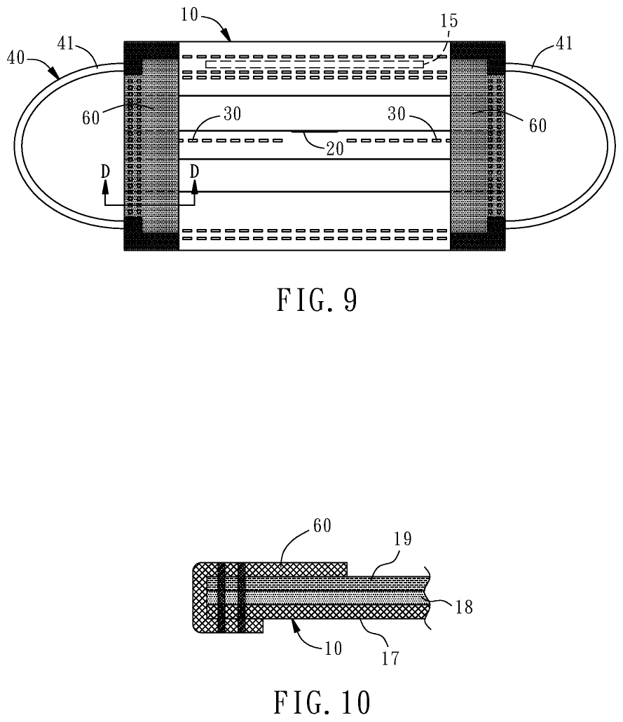

As shown in FIG. 9, FIG. 10, a third preferred embodiment of multifunctional protective mask with sucking and whistling provided by the present invention is substantially similar to the aforesaid first and second preferred embodiments. The difference between this third preferred embodiment and the previous preferred embodiments is that it also includes a pair of airtight sheets 60, which are respectively wrapped on both sides of the mask body 10, and are fixed to the mask body 10 at both ends. The airtight sheets 60 can be single-layer or multi-layer structure. When wearing the multifunctional protective mask with sucking and whistling in this third preferred embodiment, the airtight sheets 60 can be tightly attached along the sides of the face, effectively sealing the face, preventing the mask from leaking, greatly improving the tightness, and having a simple structure, and the process yield (i.e. product success rate) is high and the cost is low.

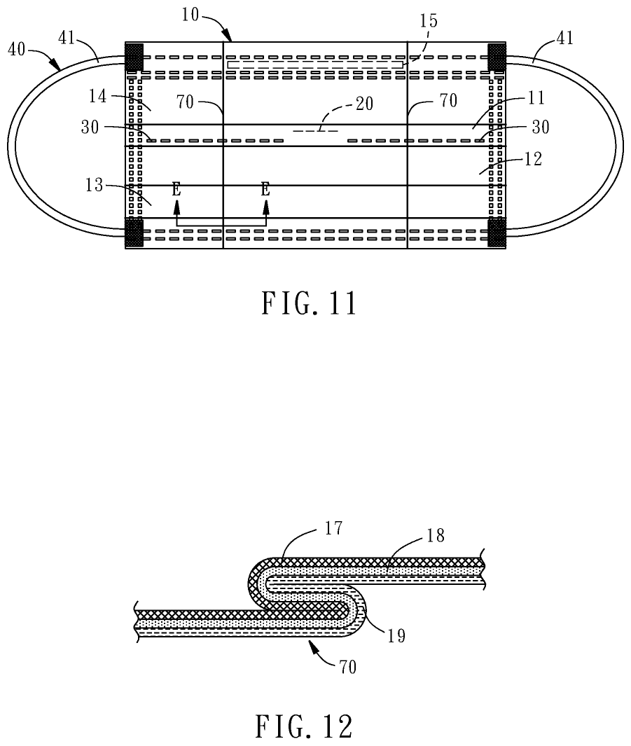

As shown in FIG. 11, FIG. 12, a fourth preferred embodiment of multifunctional protective mask with sucking and whistling provided by the present invention is substantially similar to the aforesaid first, second and third preferred embodiments. The difference between this fourth preferred embodiment and the previous preferred embodiments is that the mask body 10 is formed with at least two longitudinal wrinkles 70, which are located on the left and right sides of the nose bridge piece 15, and pass through the first wrinkle 11, the second wrinkle 12, the third wrinkle 13 and the fourth wrinkle 14. Therefore, when unfolding the wrinkles, a three-dimensional space can be formed to achieve smooth breathing, natural speech, comfortable wearing, and beautiful appearance.

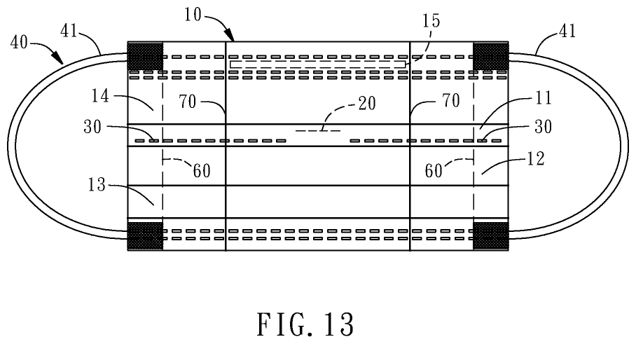

As shown in FIG. 13, a fifth preferred embodiment of multifunctional protective mask with sucking and whistling provided by the present invention is substantially similar to the aforesaid first, second, third and fourth preferred embodiments. The difference between this fifth preferred embodiment and the previous preferred embodiments is that the mask body 10 is formed with longitudinal wrinkles 70 and airtight sheets 60. The longitudinal wrinkles 70 pass through the first wrinkle 11, the second wrinkle 12, the third wrinkle 13 and the fourth wrinkle 14. The airtight sheets 60 are wrapped around the sides of the mask body 10. Therefore, the multifunctional protective mask with sucking and whistling in this fifth embodiment can form a three-dimensional space after unfolding to achieve smooth breathing, natural speech, and can effectively prevent the side leakage of the mask and greatly improve the tightness of the mask.

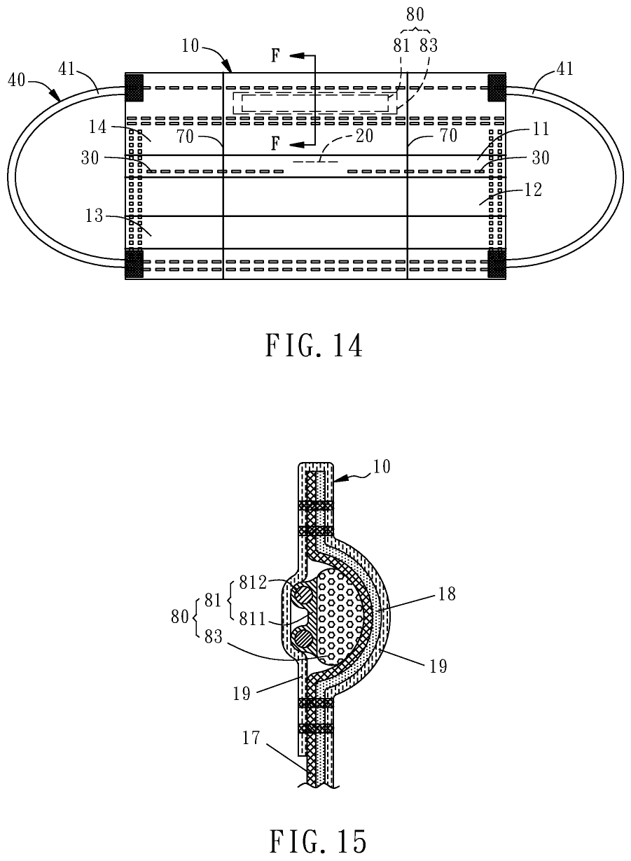

As shown in FIG. 14 and FIG. 15, a sixth preferred embodiment of multifunctional protective mask with sucking and whistling provided by the present invention is substantially similar to the aforesaid first, second, third, fourth and fifth preferred embodiments. The difference between this sixth preferred embodiment and the previous preferred embodiments is that it also includes an implantable nose pad 80, which is arranged in the upper part of the mask body 10. The implantable nose pad 80 comprises a nose bridge 81 and an elastic body 83. The nose bridge 81 is composed of a plastic member 811 and metal wires 812 embedded in the plastic member 811. The elastic member 83 can be foam or an air bag, etc. Using implantable nose pad 80 can be close to the bridge of the nose, effectively preventing dust and particles from entering from the nose bridge to achieve the effect of preventing germs and dust.

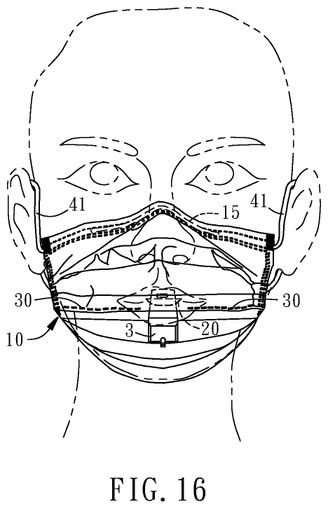

As shown in FIG. 16, a seventh preferred embodiment of multifunctional protective mask with sucking and whistling is provided by the present invention. The difference between this seventh preferred embodiment and the previous preferred embodiments is that after wearing the multifunctional protective mask with sucking and whistling in this seventh preferred embodiment, the whistle 3 can be inserted into the slit 20 of the mask body 10 and inserted into the mouth. When the traffic police wear masks on duty, it can still be convenient to blow the whistle for traffic control or perform other duties. The aforementioned functions and effects can be achieved.

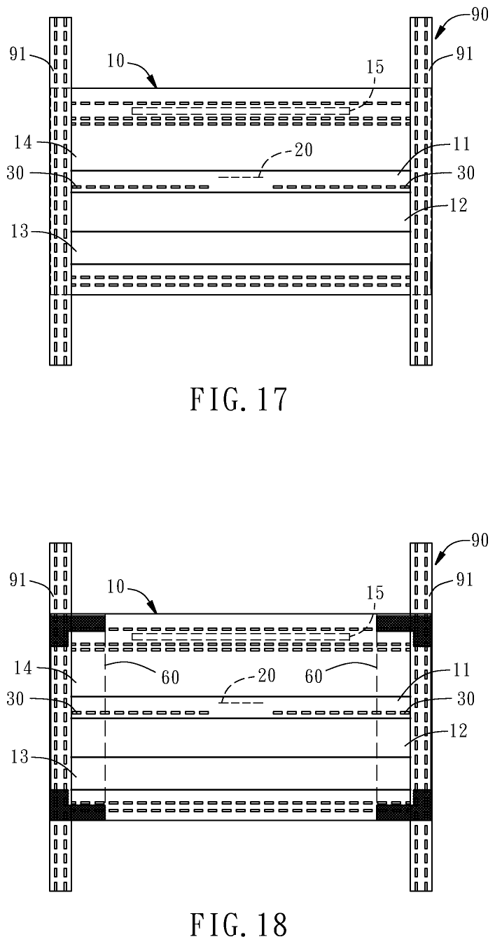

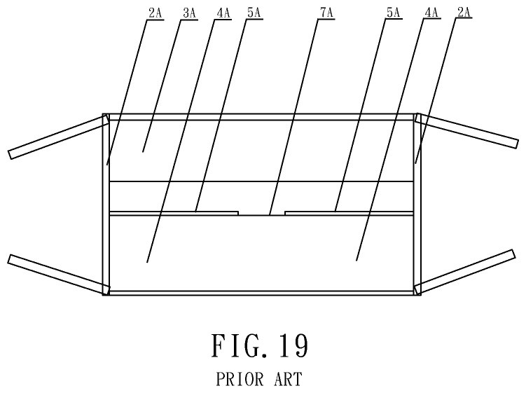

As shown in FIG. 17, an eighth preferred embodiment of multifunctional protective mask with sucking and whistling is provided by the present invention. The difference between this eighth preferred embodiment and the previous preferred embodiment is that it also includes a binding strap set 90. The binding strap set 90 comprises at least two binding straps 91. The binding straps 91 are fixed along the left and right sides of the mask body 10, and their ends extend outside the mask body 10. The length of the binding straps 91 can preferably be between 40 and 95 cm (i.e., centimeters). When in use, the binding straps 91 can be tied to the head and fixed. In addition, the binding straps 91 can also be fixed along the upper and lower sides of the mask body 10.

As shown in FIG. 17, a ninth preferred embodiment of multifunctional protective mask with sucking and whistling is provided by the present invention. The difference between this ninth preferred embodiment and the previous preferred embodiment is that it also includes a binding strap set 90 and airtight sheets 60. The binding strap set 90 comprises at least two binding straps 91. The binding straps 91 are fixed along the left and right sides of the mask body 10, and their ends extend outside the mask body 10. The airtight sheets 60 are respectively wrapped on both sides of the mask body 10, and the two ends are fixed to the mask body 10. Therefore, after wearing the multifunctional protective mask with sucking and whistling in this ninth preferred embodiment, first unfold the mask body 10 and bind the binding straps 91 to the head. The airtight sheets 60 can be tightly attached along the sides of the face to effectively seal the face, preventing the mask from leaking, and greatly improving the tightness.

In summary, compared with the prior art, the present invention has the following beneficial effects: When wearing the multifunctional protective mask with sucking and whistling of the present invention, the user can still conveniently perform multiple operations such as sucking tea, coffee, beverages, nasogastric tube feeding or whistling, while preventing the mask from leaking and maintaining good bacterial and virus filtration efficiency (PFE/BFE) and closeness. The invention has many advantages such as automatic production, short process time, low cost, and easy commercialization.

In summary, the aforesaid preferred embodiments are only examples of the present invention, and are not used to limit the scope of implementation of the present invention. The structure, size, installation position and shape of each component can be changed. On the basis of the technical solution of the present invention, all improvements and equivalent transformations performed on individual components according to the principles of the present invention should not be excluded from the protection scope of the present invention.

1. A multifunctional protective mask with sucking and whistling, comprising a mask body, a slit and a fixing section, wherein said mask body comprises folded first wrinkle and second wrinkle, and a splicing section formed at the junction of said first wrinkle and said second wrinkle; said slit is located between said second wrinkle and said splicing section; said fixing section fixes said first wrinkle, said splicing section and said second wrinkle.

2. The multifunctional protective mask with sucking and whistling as claimed in claim 1, wherein said fixing section is located on left and right sides under said slit.

3. The multifunctional protective mask with sucking and whistling as claimed in claim 2, wherein said fixing section is parallel to said slit, and the length of said slit is in the range of 5 mm-60 mm.

4. The multifunctional protective mask with sucking and whistling as claimed in claim 2, further comprising a binding strap set, said binding strap set comprising a plurality of binding straps respectively fixed along two opposite sides of said mask body.

5. The multifunctional protective mask with sucking and whistling as claimed in claim 2, further comprising a pair of reflexed sheets, said pair of reflexed sheets extending from two opposite sides of said mask body and being fixed to said mask body with ends thereof after being folded back.

6. The multifunctional protective mask with sucking and whistling as claimed in claim 2, further comprising a pair of airtight sheets, said airtight sheets being respectively wrapped on two opposite sides of said mask body with ends thereof fixed to said mask body.

7. The multifunctional protective mask with sucking and whistling as claimed in claim 6, wherein said airtight sheets are selectively a single-layer structure or a multi-layer structure.

8. The multifunctional protective mask with sucking and whistling as claimed in claim 2, wherein said mask body is formed with two longitudinal wrinkles, said longitudinal wrinkles passing through said first wrinkle and said second wrinkle respectively.

9. The multifunctional protective mask with sucking and whistling as claimed in claim 2, wherein said mask body has a zigzag cross section.

10. The multifunctional protective mask with sucking and whistling as claimed in claim 2, further comprising an implantable nose pad arranged in an upper part of said mask body.
